(19) United States
(12) Patent Application Publication
(10) Pub. No.: US 2022/0026274 A1
(43) Pub. Date: Jan. 27, 2022

(54) A TUNABLE FILTER HAVING DIFFERENT GAPS

(71) Applicant: Unispectral Ltd., Ramat Gan (IL)

(72) Inventor: Peleg LEVIN, Rishon LeZion (IL)

(21) Appl. No.: 17/297,391

(22) PCT Filed: Nov. 24, 2019
(86) PCT No.: PCT/IL2019/051283

§ 371 Date: May 26, 2021

Related U.S. Application Data
(60) Provisional application No. 62/806,915, filed on Feb. 18, 2019.
(60) Provisional application No. 62/771,198, filed on Nov. 26, 2018.

(51) Int. Cl. G01J 3/26; G02B 6/293; G02B 26/02; G02B 7/188

(52) U.S. Cl. CPC G01J 3/26; G02B 7/188; G02B 26/02; G02B 6/293

(57) ABSTRACT

A tunable filter that may include a pair of optical components, wherein there is an optical gap between the pair of optical components; and a pair of actuating elements that are configured, once supplied with at least one actuating signal, to be positioned at an actuation gap from each other and to define the optical gap; and wherein the optical gap is substantially smaller than the actuation gap.

### BACKGROUND

A Fabry-Perot filter typically has of a pair of partially reflecting flat optical surfaces precisely positioned in parallel to form a uniform optical gap. As light, at wavelengths correlating with the gap size, passes through the filter, its intensity is modified due to interference. Accordingly, the locations of the peaks in the transmission spectra of the filter are dictated by the optical gap size. Fabry-Perot filters designed for the wavelength range between the visible and up to near infra-red (VIS-NIR) spectrum, which is to say, between 400 nm and 1100 nm, typically have an optical gap in the range of a few hundreds to a few thousands of nm. At extremely small gaps, of the order of 30 nm and less, with some optical coatings the filter's effect on the VIS-NIR spectrum is negligible and the device works in a so-called transparent mode. While first publications on tunable VIS-NIR microelectromechanical systems (MEMS) Fabry-Perot filters date back to the nineties, many challenges remain to be addressed such as spectral tunability, overall size, reliability, and integrability with electronics.

Architectures of the most common electrostatically tunable micro Fabry-Perot filters (μFPFs) incorporate a movable semi-transparent mirror suspended, by means of elastic flexures, at a certain distance from a stationary, either reflective or transparent, mirror.

Since the electrodes used for the actuation are co-planar with the optical surfaces of the movable mirror, the electrostatic and the optical gaps are of a similar size, and are both reduced with the increase of the operational voltage.

Close-gap electrostatic actuators are prone to the so-called pull-in instability, when the device collapses toward the electrode at an actuation voltage exceeding a certain critical value. As a result, the optical gap tuning range of electrostatic μFPFs is limited to approximately one third of the initial un-actuated gap size. Utilizing the stress-stiffening effect in double-clamped suspension beams, or implementing an integrated series capacitors, may allow a certain increase in the stable tunable range, reaching minimal gaps of approximately half of the initial un-actuated gap size. However, the actuation-related coupling between the optical and electrostatic gaps still inherently limits the tuning range of the existing μFPFs.

### SUMMARY

A tunable filter and a method for controlling a tunable filter as illustrate din the specification and/or the drawings.

### BRIEF DESCRIPTION OF THE DRAWINGS

In order to understand the invention and to see how it may be carried out in practice, a preferred embodiment will now be described, by way of non-limiting example only, with reference to the accompanying drawings.

FIG. 1 is an example of a tunable filter;

FIG. 2 is an example of a tunable filter;

FIG. 3 is an example of a tunable filter;

FIG. 4 is an example of a tunable filter;

FIG. 5 is an example of a tunable filter;

FIG. 6 is an example of a tunable filter;

FIG. 7 is an example of a tunable filter;

FIG. 8 is an example of a tunable filter;

FIG. 9 is an example of a tunable filter;

FIG. 10 is an example of a tunable filter;

FIG. 11 is an example of a tunable filter;

FIG. 12 is an example of a tunable filter;

FIG. 13 is an example of a tunable filter;

FIG. 14 is an example of a tunable filter;

FIG. 15 is an example of a tunable filter;

FIG. 16 is an example of a tunable filter;

FIG. 17 is an example of a tunable filter;

FIG. 18 is an example of a tunable filter;

FIG. 19 is an example of a tunable filter;

FIG. 20 is an example of a tunable filter;

FIG. 21 is an example of a tunable filter;

FIG. 22 is an example of a tunable filter;

FIG. 23 is an example of a tunable filter;

FIG. 24 is an example of a tunable filter;

FIG. 25 is an example of a tunable filter;

FIG. 26 is an example of a tunable filter;

FIG. 27 is an example of a tunable filter;

FIG. 28 is an example of a tunable filter;

FIG. 29 is an example of a tunable filter; and

FIG. 30 is an example of a tunable filter;

### DETAILED DESCRIPTION OF THE DRAWINGS

The term “and/or” is additionally or alternatively.

Each one of the figures may be of scale or may be out of scale.

Any reference to a device or to a tunable filter should be applied, mutatis mutandis to a method that is executed by a device or tunable filter.

Any reference to method should be applied, mutatis mutandis to a device or to a tunable filter that is configured to execute the method.

There may be provided a tunable filter that may be included in a device. The device may include an image sensor. The tunable filter may precede the image sensor in the sense that radiation passes through the tunable filter before reaching the image sensor.

The image sensor may be configured to acquire images. The image sensor may include sensing elements that corresponds to pixels.

There may be provided a tunable filter that may include (a) optical components that at least partially participate in an optical filtering operation applied by the tunable filter, and (b) actuating elements (such as actuator electrodes) between which an actuation force may be applied. The actuation force defines an actuation gap between the actuation elements that correlates with a certain optical gap between the optical components. The optical gap is substantially smaller than the actuation gap or in times substantially smaller than the actuation gap.

For example—substantially smaller may mean that an un-actuated optical gap is smaller by 10%-90% (or any subset of this range) than an un-actuated actuation gap. It may also mean that the minimal actuation gap may be at least twice of the optical gap.

Yet for another example—substantially smaller may mean that a minimal optical gap is smaller by 10-1000 nanometers (or any subset of this range) than a minimal actuation gap.

Yet for another example—substantially smaller may mean that un-actuated optical gap is smaller by 10-300 nanometers (or any subset of this range) than un-actuated actuation gap.

Yet for another example—For optical gap tunable in the range of 30-500 nm by means of electrostatic actuation, the un-actuated electrostatic and optical gaps may be 530 nm and 500 nm, respectively, while at the minimal actuated optical gap of 30 nm, the electrostatic gap is at least double than that number, i.e. 60 nm.

Yet for another example—an optical gap that is substantially smaller than the actuating gap (having an actuation gap that is substantially larger than the optical gap) may be configured to prevent pull-in instability due to the actuation gap size.

In some tunable filters a maximal actuation gap is provided when no actuation force is applied. In other tunable filters a minimal actuation gap may be provided when no actuation force is applied.

For simplicity of explanation it is assumed that there are two optical components and two actuation elements. It should be noted that a tunable filter may include more than two optical components and/or more than two actuation elements.

For simplicity of explanation it is assumed that the tunable filter is a Fabry-Perot filter—but other tunable filters may be provided. The tunable filter may be a MEMS tunable filter—either a MEMS Fabry-Perot filter or a MEMS tunable filter than differs from a MEMS Fabry-Perot tunable filter.

For simplicity of explanation it is assumed that the optical elements include a static optical element and a movable optical element. It should be noted that the tunable filter may include more than one movable optical element and may include zero or more static optical elements.

The actuation gap may be set to exceed the optical gap by misaligning (for example—positioning within different horizontal planes) an inner surface of an actuation element and an inner surface of an optical element that is mechanically coupled to the actuation element. The actuation gap may be set to exceed the optical gap by putting an actuating element such as an electrode on an exterior surface of the bottom fixed member. In this case the inner surface of the actuating element is misaligned with the inner surface of the optical element as the inner surface of the actuating element is below the inner surface of the optical element. Yet for another example—a misalignment can be obtained by forming cavities in an actuation element—and placing the inner surface of the actuation elements closer to a center of an inner space in relation to the inner surface of the optical element. The inner space is located between the optical elements.

An actuation element may be located within or without a cavity, space, trench, or void formed within a component of the tunable filter.

There may be provided a tunable filter that may include (a) a first member that may include a first optical region and one or more first actuation elements; (b) a second member that may include a second optical region corresponding to the first optical region defining a tunable optical gap therebetween. Each of the one or more first actuation elements may have a corresponding second actuation element, defining an actuation couple, each actuation couple defines an actuation gap therebetween. Each actuation couple may be configured to apply an actuation signal resulting in a tuning of the optical gap. Each of the actuation gaps is greater than the optical gap.

In some embodiments of the tunable filter, the first member is a movable member and the second member is a stationary member. It is to be noted that this is an arbitrary selection and each of the first and second members can serve both functions.

It is to be noted that the tuning of the optical gap that is resulted by the actuation signal refers to any change in the optical configuration between the first and the second optical regions, i.e. a change in the distance between the centers of the optical regions, a tilt change between the first and the second optical regions, etc.

Each actuation element may be an electrode, a conductor, a conductive semiconductor, and the like.

The one or more first actuation elements may span a plane parallel to a plane spanned by the first optical region. The one or more second actuation elements may span a plane parallel to a plane spanned by the second optical region. It is to be noted that planes spanned by the actuation regions or elements may be of different levels than those spanned by the first and second optical regions. For example, the first actuation regions may be formed in a first layer, wherein the first layer is applied on or attached to a second layer that comprises the first optical region. In some embodiments, the first layer is formed of or comprises silicon and the second layer is formed of or comprises glass.

Upon actuation the optical gap may decrease from a maximal optical gap or increase from a minimal optical gap.

At least one of the first and the second members may include or may be integral with at least one stopper element that is configured to stop the movable member at a minimal optical and/or minimal actuation gap.

In some embodiments, one of the first and second members is a movable member and the other is stationary member.

The relation between the actuation gap and the optical gap may be such that the entire range of the optical gap, namely between a minimal optical gap and a maximal optical gap, is enabled by actuation signal that does not result in a pull-in instability.

The minimal actuation gap may be at least two folds or three folds larger than the minimal optical gap.

A non-actuated maximal actuation gap is larger than a non-actuated maximal optical gap.

At least one of the one or more first and second actuation elements may be formed by a portion of processed silicon.

In the tunable filter, the processed silicon may be etched, e.g. deep reactive ion-etched.

A conductive or semi-conductive structure may be formed on the portion of the processed silicon.

The silicon may be a doped silicon, for example boron doped silicon.

At least one of the one more first and second actuation elements may be constituted by a conductive or semi-conductive structure that may be formed on a portion of processed transparent/semi-transparent material, e.g. glass, plastic, silicon, polymer, germanium or polymer. The transparent/semi-transparent material may be any material with suitable transparency to light in a desired wavelength range for the tunable filter and the image sensor to function in a desired way. The transparent/semi-transparent material may be etched. The transparent/semi-transparent material may be ITO (indium-tin-oxide).

Each one of the first and second actuation elements may be spatially separated from the first and second optical regions.

The actuation may involve one or more out of electrostatic actuation, magnetic actuation, electrostrictive actuation, piezoelectric actuation, and kelvin polarization force actuation.

The stationary member may include the second actuation elements.

The actuation gap may decrease or increase upon actuation.

The actuation gap may span a gaseous medium.

The gaseous medium may include inert gas, air, or low pressure conditions, e.g. vacuum.

The actuation gap may include one or more mediums, e.g. air and glass.

Upon actuation, the optical gap may decrease.

The one or more first actuation elements generally face the stationary member.

The tunable filter may be an etalon filter.

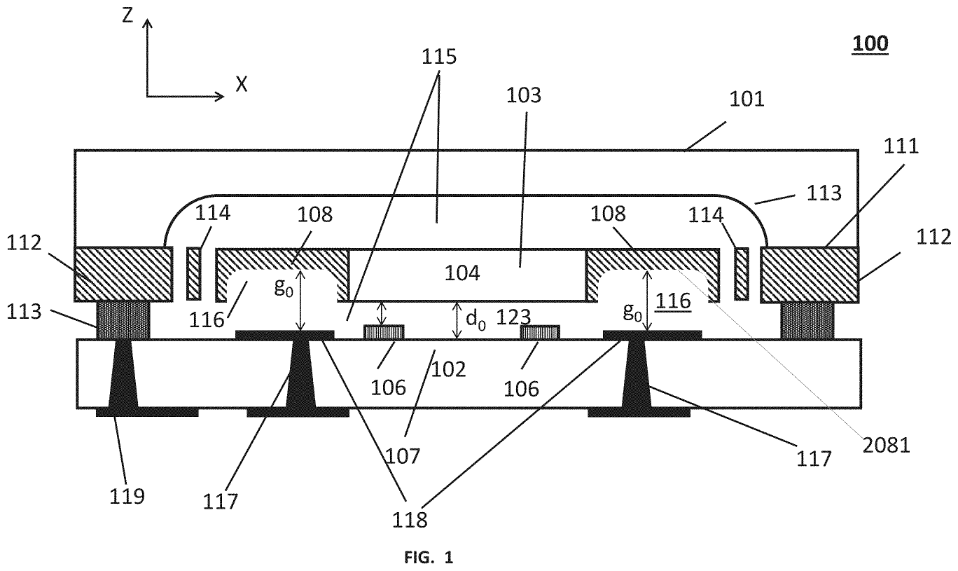

FIGS. 1-28 illustrate examples of tunable filters such as Fabry-Perot filters.

For simplicity of explanation only some images illustrate a cap. It should be noted that the cap may not be included in the tunable filter—for example when a flexible and sealed membrane is used as the flexible element in the movable member, in which case the device is sealed and no cap is needed.

In the figures described below various examples of tunable filters that are designed with an optical gap smaller than then actuation gap are provided. By configuring a tunable filter according to these principles the tuning range of the filter is increased enabling a smaller optical gap while avoiding pull-in instability which is otherwise caused by the actuation gap.

Furthermore, in the figures, structures having a white filling exemplify components made of glass or other transparent/semi-transparent substrates and structures filled with diagonal stripes are components made of silicon.

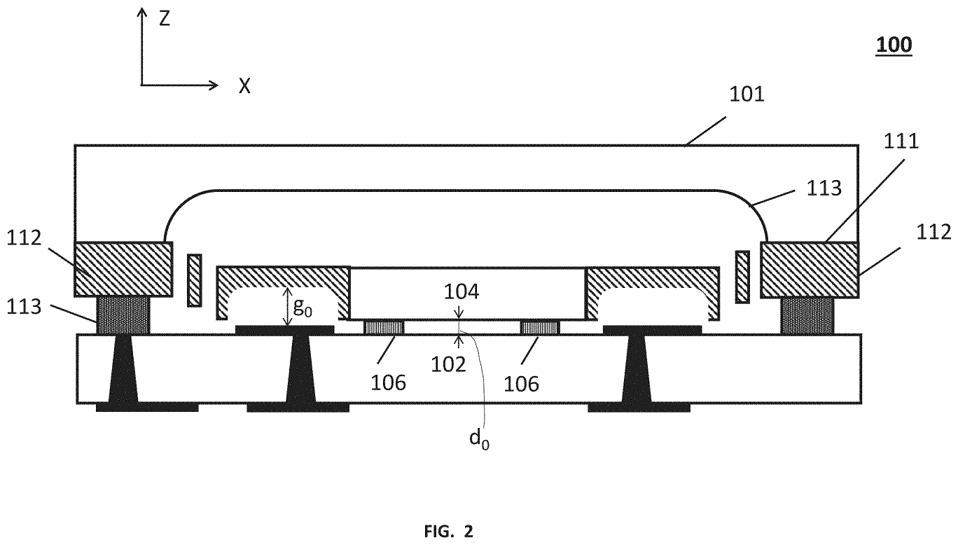

FIGS. 1 and 2 illustrate cross sections of different states of an example of a tunable filter according to an embodiment of the present disclosure. The tunable filter 100 includes a movable member 104 that moves with respect to a stationary member 102 and a static frame 112 due to flexible elements 114, e.g. springs, linking it to the frame 112. The movable member includes an optical region 103 in its center and first actuation regions/elements 108 that are integral with the first optical region 103, namely that move together with the first optical region, for example by being formed of a single wafer. The stationary member 102 includes a second optical region 107 that defines with the first optical region 103 an optical gap do, which determines the spectral response of the tunable filter, and second actuation regions/elements 118. Each actuation region 118 corresponds to a first actuation region 108 in the movable member to form an actuation couple. Each actuation couple is configured to affect the optical gap do (and also the actuation gap) that is defined between the first optical region and the second optical region. For example, by applying voltage difference between a first actuation region and a corresponding second actuation region, an electrostatic force is applied on the movable member that results in a change of the optical gap. The first actuation regions 108 are formed in a recess/cavity 116 in the movable member such that the actuation gap go is greater than the optical gap do at any time. That avoids the pull-in instability phenomena from occurring. In particular, the actuation regions are formed in an inner surface 2081 of the recess 116.

The second actuation regions 118 are fed from an external source (not shown) by through-glass vias 117.

Stopper elements 106 are formed on the stationary member 102 and are protruding towards the movable member to certain dimension to define a minimal gap between the movable member and stationary member.

The tunable filter 100 further includes a cap element 101 that is sealingly attached to the frame 112 by a bond 111 to define an air-tight sealed enclosure 115. A feed element 119 is configured to receive and transmit actuation signals to one or more of the first actuation regions through an eutectic bond 113. It is to be noted that the feed element 119 may also serve as a ground connection.

The first optical region 103, the second optical region 107 and at least a portion of the cap are made of transparent or semi-transparent material for a desired bandwidth of light, e.g. glass, plastic, silicon, polymer, germanium

In other words, an optical gap do is formed between stationary member 102 and movable member 104 and may define the spectral response of the tunable filter 100.

The optical gap is defined by an actuation gap go between the one or more first actuation elements 108 and the one or more second actuation elements 118.

The value of the actuation gap may be defined by a provision (or lack of provision) of actuation signals.

Different values of the actuation gap provide different values of the optical gap—and a difference between filtering parameters of the optical filter. The filtering parameter may represent one or more frequencies that are not rejected (filtered out) by the tunable filter, one or more frequencies that are rejected by the tunable filter, and the like.

When there are multiple first actuation elements and/or multiple second actuation elements then there may be defined multiple actuation gaps that may define multiple optical gaps. In this case any actuation gap may exceed an its corresponding optical gap.

In FIG. 1 cavities 116 are formed in the first actuation elements 108 thereby increasing the actuation gap—and obtaining a difference between the actuation gap and the optical gap.

In FIG. 1 the movable member 104 is positioned in an elevated state, while in FIG. 2 the movable member 104 is located at its lowest state in which the movable member 104 contacts stoppers 106.

In FIGS. 1 and 2 there is a misalignment between the inner surface 2081 of the first actuation element 108 and the inner surface of the movable member 104—the bottom of the movable member 104 is lower than the bottom of cavity 116.

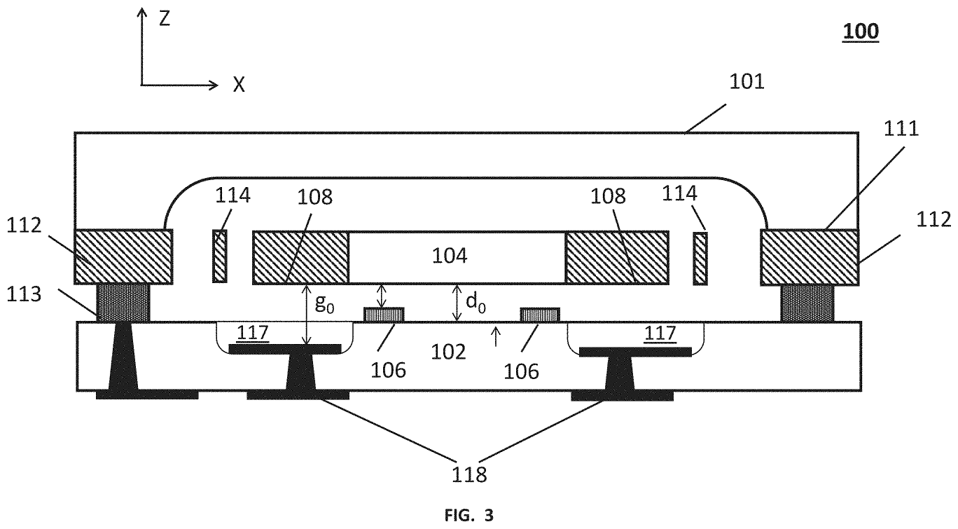

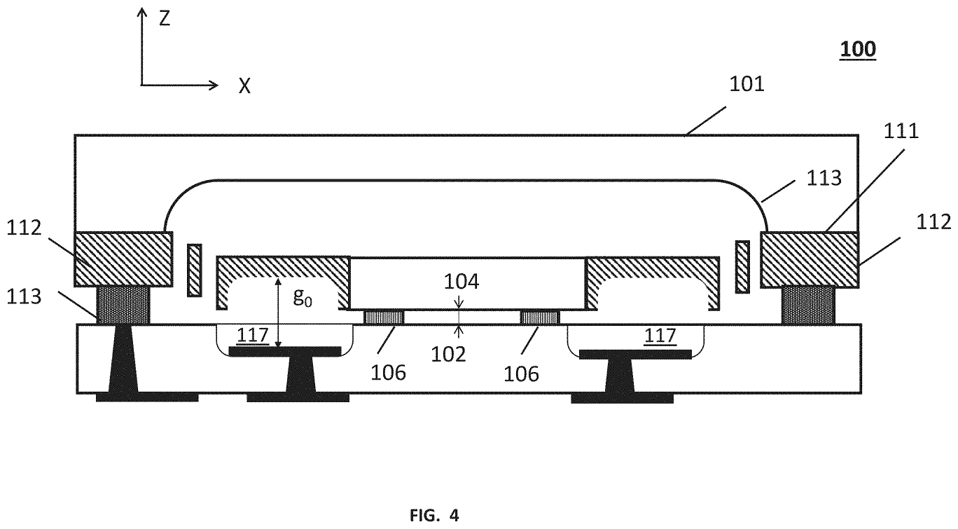

FIGS. 3 and 4 illustrate cross sections of a tunable filter 100 that includes: cap 101, stationary member 102, movable member 104, stopper elements 106, one or more first actuation elements 108, static frame 112, one or more flexible elements 114 such as a spring that is mechanically coupled between frame 112 and first actuation elements 108, one or more second actuation elements 118 and a bond (113) formed between frame 112 and static element 102.

The first actuation elements 108 are connected to the movable member 104. The first actuation elements 108 follow a movement of the movable member. The one or more flexible elements 114 support the movable member 104 regardless of the position of the movable member 104.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

Cavities/recesses 117 are formed in the static member 102. Placing an upper part of the second actuation elements 118 within the cavities 117—increases the actuation gap—and obtaining a difference between the actuation gap and the optical gap.

In FIG. 4, the first actuation regions are formed in a recess of a portion of the movable member.

In FIG. 3 the movable member 104 is positioned in an elevated state, while in FIG. 4 the movable member 104 is located at its lowest state in which the movable member 104 contacts stoppers 106.

In FIGS. 3 and 4 there is a misalignment between the inner surface of the second actuation elements 118 (upper part of the second actuation elements) and the inner surface of the static member 102—the top of the static member 102 is higher than the upper part of the second actuation elements 118.

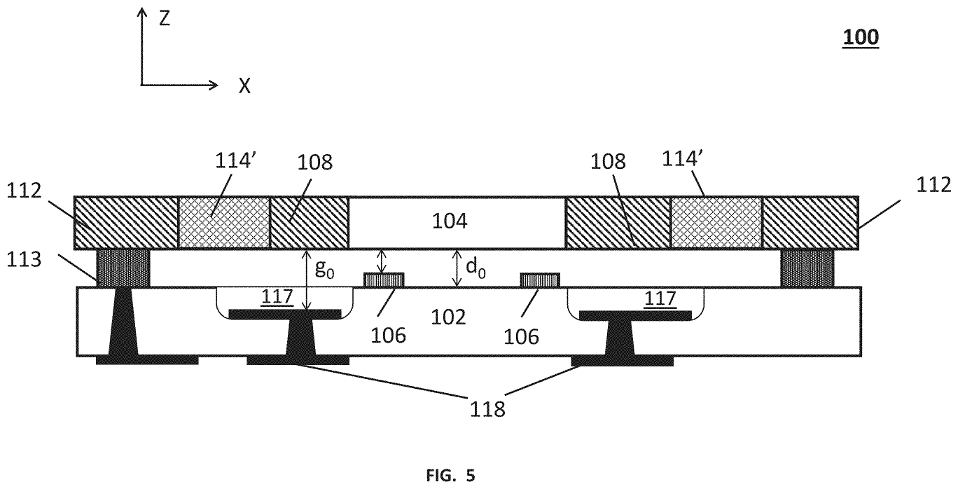

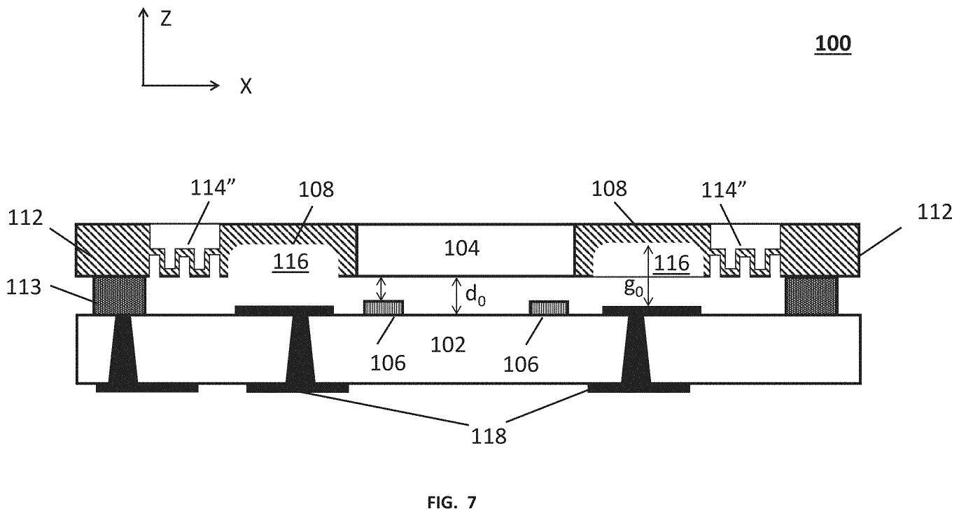

FIGS. 5-9 exemplify embodiments of the tunable filter of the present disclosure, in which the flexible element(s) link the movable member to the static frame in a sealingly manner to define hermetical enclosure, which can be under low pressure conditions, between the movable member and the stationary member. In FIGS. 7-9, the flexible element is in the form of a sealed membrane. In these embodiments, the tunable filter does not include a cap element.

FIG. 5 is a cross section of a tunable filter 100 that includes: stationary member 102, movable member 104, stopper elements 106, one or more first actuation elements 108, static frame 112, one or more flexible elements 114′ that is mechanically coupled between frame 112 and first actuation elements 108—and hermetically seals the gap between the frame 112 and first actuation elements 108 (thereby eliminating the need to have a cap), one or more second actuation elements 118 and a bond 113 formed between frame 112 and static element 102.

The first actuation elements 108 are connected to the movable member 104. The first actuation elements 108 follow a movement of the movable member. The one or more flexible elements 114′ support the movable member 104 regardless of the position of the movable member 104.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

Cavities 117 are formed in the static member 102. Placing an upper part of the second actuation elements 118 within the cavities 117—increases the actuation gap—and obtaining a difference between the actuation gap and the optical gap.

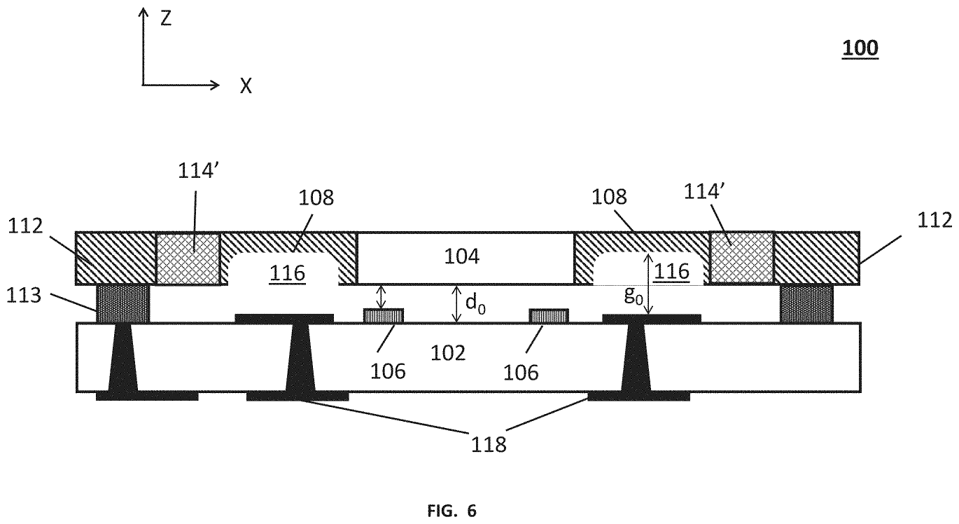

FIG. 6 is a cross section of a tunable filter 100 that includes, stationary member 102, movable member 104, stopper elements 106, one or more first actuation elements 108, static frame 112, one or more flexible elements 114′ that is mechanically coupled between frame 112 and first actuation elements 108—and hermetically seals the gap between the frame 112 and first actuation elements 108 (thereby eliminating the need to have a cap), one or more second actuation elements 118 and a bond 113 formed between frame 112 and static element 102.

The first actuation elements 108 are connected to the movable member 104. The first actuation elements 108 follow a movement of the movable member. The one or more flexible elements 114′ support the movable member 104 regardless of the position of the movable member 104.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

In FIG. 6 cavities 116 are formed in the first actuation elements 108 thereby increasing the actuation gap—and obtaining a difference between the actuation gap and the optical gap.

FIG. 7 is a cross section of a tunable filter 100 that includes, stationary member 102, movable member 104, stopper elements 106, one or more first actuation elements 108, static frame 112, one or more flexible elements 114″ that have a serpentine cross section and are mechanically coupled between frame 112 and first actuation elements 108—and hermetically seal the gap between the frame 112 and first actuation elements 108 (thereby eliminating the need to have a cap), one or more second actuation elements 118 and a bond 113 formed between frame 112 and static element 102. The one or more flexible elements may have a radial symmetry—thus forming a flexible membrane/corrugated diaphragm.

The first actuation elements 108 are connected to the movable member 104. The first actuation elements 108 follow a movement of the movable member. The one or more flexible elements 114″ support the movable member 104 regardless of the position of the movable member 104.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

In FIG. 7 cavities 116 are formed in the first actuation elements 108 thereby increasing the actuation gap—and obtaining a difference between the actuation gap and the optical gap.

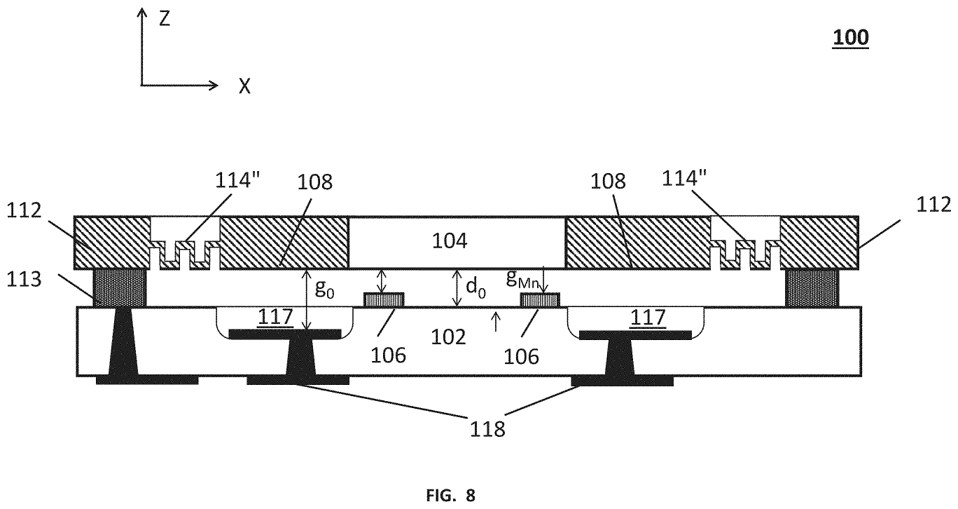

FIG. 8 is a cross section of a tunable filter 100 that includes, stationary member 102, movable member 104, stopper elements 106, one or more first actuation elements 108, static frame 112, one or more flexible elements 114″ that have a serpentine cross section and are mechanically coupled between frame 112 and first actuation elements 108—and hermetically seal the gap between the frame 112 and first actuation elements 108 (thereby eliminating the need to have a cap), one or more second actuation elements 118 and a bond 113 formed between frame 112 and static element 102. The one or more flexible elements may have a radial symmetry—thus forming a flexible membrane/corrugated diaphragm.

The first actuation elements 108 are connected to the movable member 104. The first actuation elements 108 follow a movement of the movable member. The one or more flexible elements 114″ support the movable member 104 regardless of the position of the movable member 104.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

In FIG. 8 cavities 117 are formed in the static member 102. Placing an upper part of the second actuation elements 118 within the cavities 117—increases the actuation gap—and obtaining a difference between the actuation gap and the optical gap.

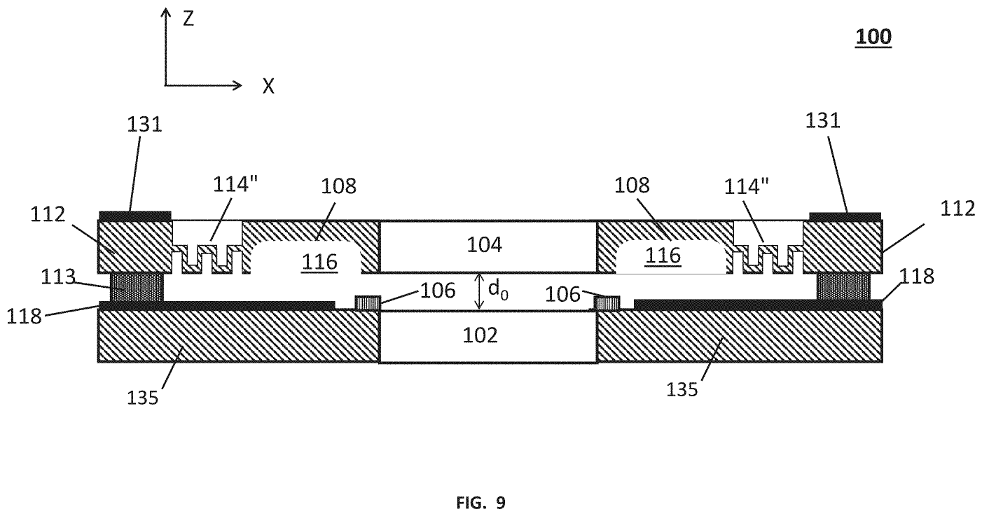

FIG. 9 is a cross section of a tunable filter 100 that includes, stationary member 102, movable member 104, feeding pads 131, stopper elements 106, one or more first actuation elements 108, static frame 112, one or more flexible elements 114″ that have a serpentine cross section and are mechanically coupled between frame 112 and first actuation elements 108—and hermetically seal the gap between the frame 112 and first actuation elements 108 (thereby eliminating the need to have a cap), one or more second actuation elements 118, supporting elements 135, and a bond such as eutectic bond (EB) 113 formed between frame 112 and supporting elements 135. The eutectic bond may be replaced by (or may be provided in addition to) another bond such as but not limited to glass frit bond, laser glass frit, etc. The one or more flexible elements may have a radial symmetry—thus forming a flexible membrane/corrugated diaphragm.

The first actuation elements 108 are connected to the movable member 104. The first actuation elements 108 follow a movement of the movable member. The one or more flexible elements 114″ support the movable member 104 regardless of the position of the movable member 104.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

The first actuation elements 108 are electrically coupled (via static frame 112 and one or more flexible elements 114″) to the feeding pads 131 that may feed the first actuation elements 108 with one or more actuating signals.

The one or more second actuation elements 118 and the spacers 106 are formed on the supporting elements 135.

In FIG. 9 cavities 116 are formed in the first actuation elements 108 thereby increasing the actuation gap—and obtaining a difference between the actuation gap and the optical gap.

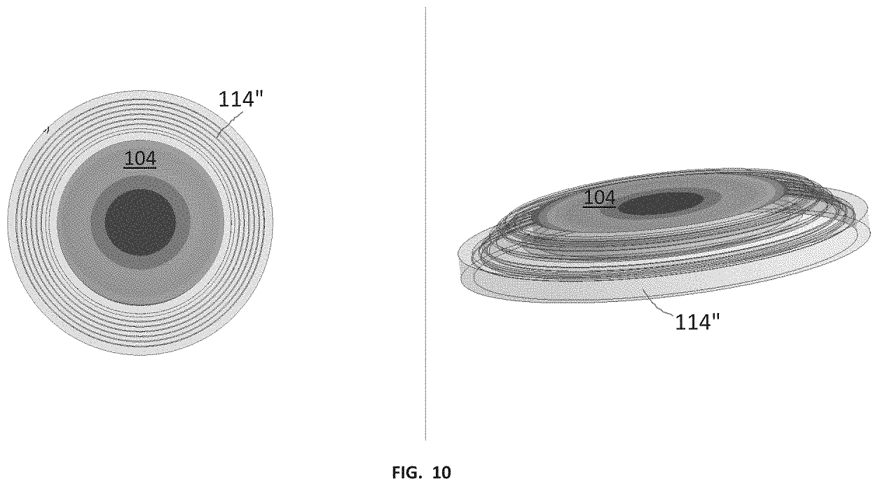

FIG. 10 illustrates an example of a simulation of the one or more flexible elements 114″ and the movable member 104. Different gray levels of the movable member 104 represents a curved surface of the movable member 104. It should be noted that the usage of the sealed flexible member, may result in applying relatively low stresses on the movable member—which may result in a relatively small deformation of the optical surface.

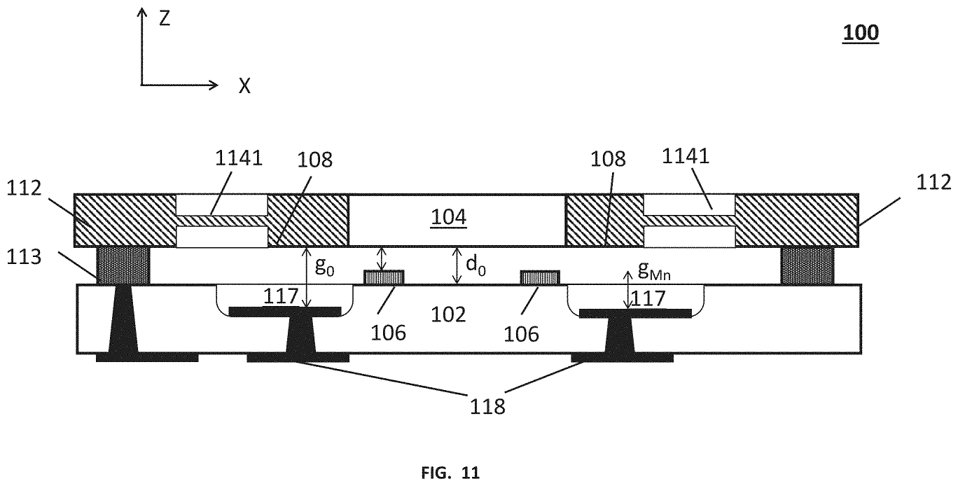

FIG. 11 is a cross section of a tunable filter 100 that includes, stationary member 102, movable member 104, stopper elements 106, one or more first actuation elements 108, static frame 112, one or more flexible elements 1141 that is thinner than the frame and is illustrated as having (in a certain state) a flat cross section and is mechanically coupled between frame 112 and first actuation elements 108—and seals the gap between the frame 112 and first actuation elements 108 (thereby eliminating the need to have a cap), one or more second actuation elements 118 and a bond 113 formed between frame 112 and static element 102. The one or more flexible elements may have a radial symmetry—thus forming a flexible membrane/corrugated diaphragm.

The first actuation elements 108 are connected to the movable member 104. The first actuation elements 108 follow a movement of the movable member. The one or more flexible elements 1141 support the movable member 104 regardless of the position of the movable member 104.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

In FIG. 11 cavities 117 are formed in the static member 102. Placing an upper part of the second actuation elements 118 within the cavities 117—increases the actuation gap—and obtaining a difference between the actuation gap and the optical gap.

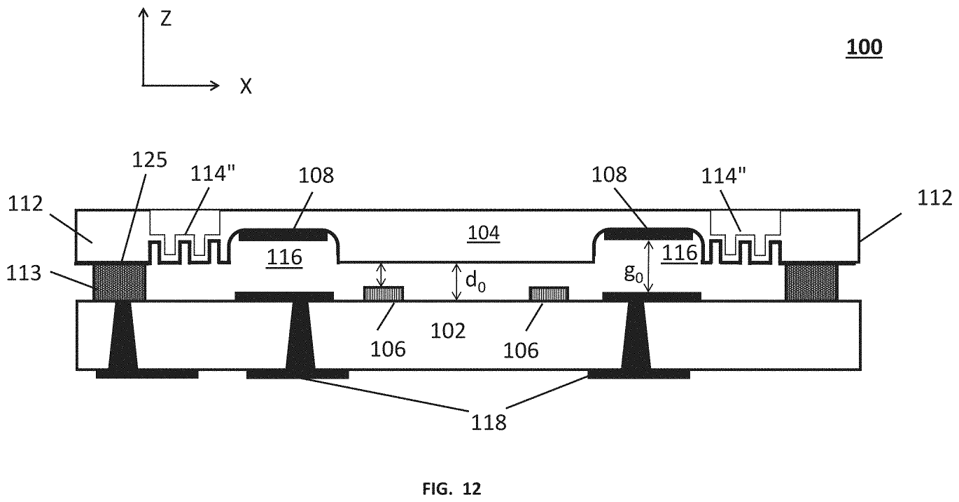

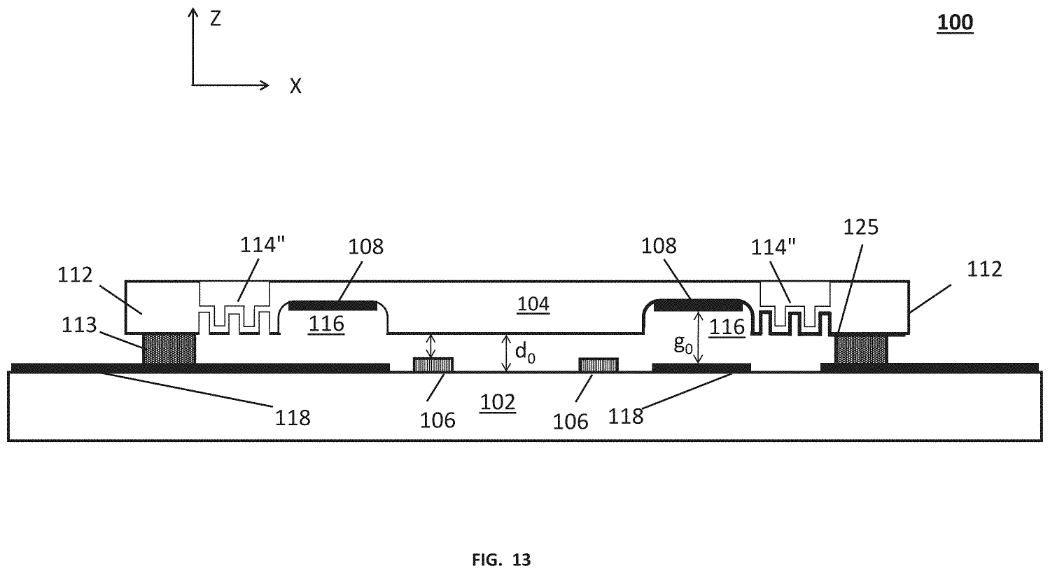

FIGS. 12 and 13 illustrate cross sections of a tunable filter 100 that includes, stationary member 102, movable member 104, stopper elements 106, one or more first actuation elements 108, static frame 112, one or more flexible elements 114″ that have a serpentine cross section and are mechanically coupled between frame 112 and first actuation elements 108—and hermetically seal the gap between the frame 112 and first actuation elements 108 (thereby eliminating the need to have a cap), one or more second actuation elements 118, supporting elements (not shown) and a bond such as DB 113 formed between frame 112. The one or more flexible elements may have a radial symmetry.

The first actuation elements 108 are connected to the movable member 104. The first actuation elements 108 follow a movement of the movable member. The one or more flexible elements 114″ support the movable member 104 regardless of the position of the movable member 104.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

In FIGS. 12 and 13 cavities 116 are formed in the first actuation elements 108 thereby increasing the actuation gap—and obtaining a difference between the actuation gap and the optical gap.

In FIGS. 12 and 13 the inner part of the frame 112, and the inner part of the one or more flexible elements 114″ are coated with electrically conducting coating 125 that electrically couples the first actuation elements 108 to an external actuation signal conductor (not shown).

In FIG. 12 the one or more second actuation elements 118 pass through the stationary member 102. In FIG. 13 the one or more second actuation elements 118 are positioned above the stationary member 102—and extend outside the dielectric bond 113.

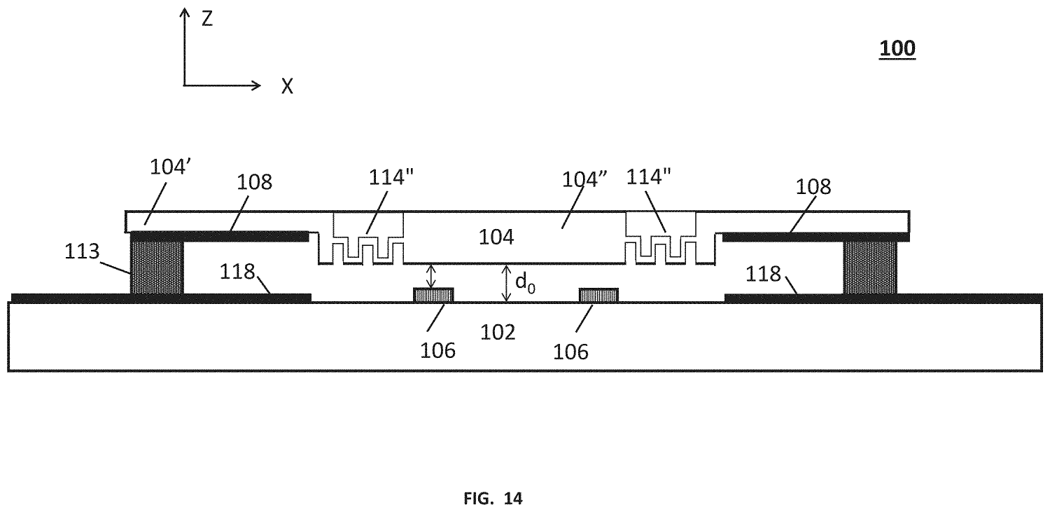

FIG. 14 is a cross section of a tunable filter 100 that includes, stationary member 102, movable member 104, stopper elements 106, one or more first actuation elements 108, one or more flexible elements 114″ that have a serpentine cross section and are mechanically coupled between and first actuation elements 108—and hermetically seal the gap between the frame 112 and first actuation elements 108 (thereby eliminating the need to have a cap), one or more second actuation elements 118, and a bond such as 113 formed between and supporting elements 135. The one or more flexible elements may have a radial symmetry—thus forming a flexible membrane/corrugated diaphragm.

The first actuation elements 108 are connected to an exterior portion 104′ of the movable member 104 that is thinner than the center 104″ of the movable member 104. An exterior part of each of the first actuation elements 108 is positioned on the bond 113 while an internal part of each of the first actuation elements 108 is free to move. One or more actuation signals may cause the internal part of each of the first actuation elements 108 to move towards the one or more second actuation elements 118 thereby bending the exterior portion 104′ of the movable member 104 towards the static member 102.

An optical gap do is formed between stationary member 102 and the center 104″ of the movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

The center 104″ of the movable member 104 is thicker than the exterior portion 104′ of the movable member 104—thereby obtaining a difference between the actuation gap and the optical gap.

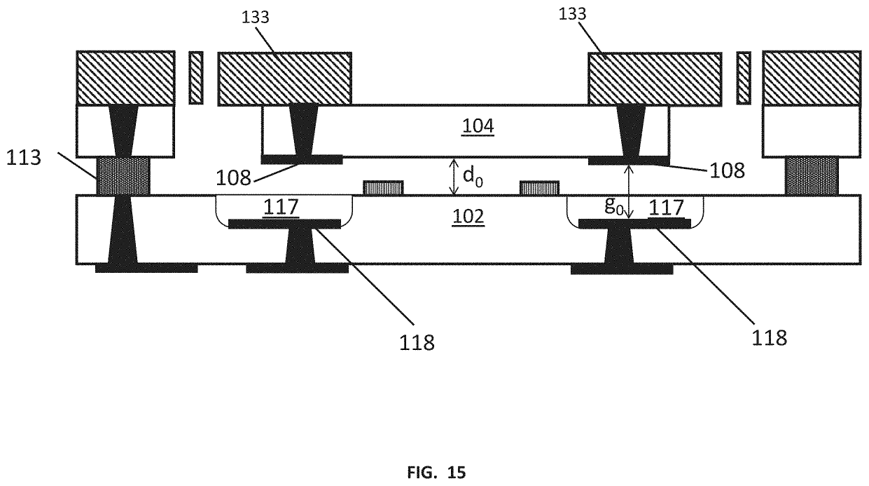

FIG. 15 is a cross section of a tunable filter 100 that includes, stationary member 102, movable member 104, stopper elements 106, one or more first actuation elements 108, static frame, one or more flexible elements that is mechanically coupled between the frame and first actuation elements 108, one or more second actuation elements 118 and a bond formed between the frame and static element 102.

The first actuation elements 108 are connected to the movable member 104. The first actuation elements 108 follow a movement of the movable member. The one or more flexible elements support the movable member 104 regardless of the position of the movable member 104.

Each one of the first actuation elements 108 has (a) an outer surface that is electrically coupled to conductive semiconductors (for example doped silicon) 133 for receiving one or more actuation signals, (b) an intermediate part that passes through the movable member 104, and (c) an inner surface that contacts the inner surface of the movable member.

An optical gap do is formed between stationary member 102 and movable member 104 and may define the spectral response of the tunable filter 100. The optical gap is defined by an actuation gap go between the inner surface of each one of the first actuation elements 108 and the second actuation elements 118. The value of the actuation gap is defined by a provision (or lack of provision) of actuation signals.

Cavities 117 are formed in the static member 102. Placing an upper part of the second actuation elements 118 within the cavities 117—increases the actuation gap—and obtaining a difference between the actuation gap and the optical gap.

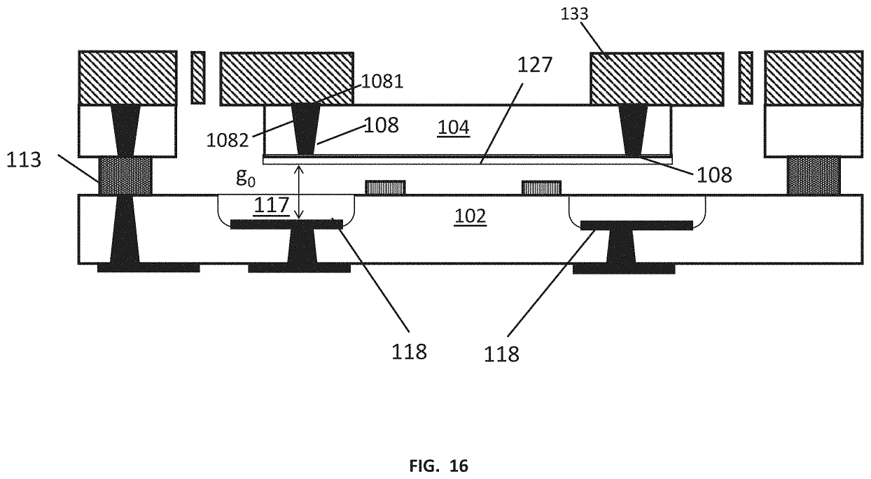

FIG. 16 is a cross section of a tunable filter 100 that includes, stationary member 102, movable member 104, stopper elements 106, a first actuation element 108, static frame 112, one or more flexible elements 114 that is mechanically coupled between frame 112 and first actuation elements 108, one or more second actuation elements 118 and a bond formed between frame 112 and static element 102.

The first actuation element 108 is connected to the movable member 104. The first actuation element 108 follows a movement of the movable member. The one or more flexible elements 114 support the movable member 104 regardless of the position of the movable member 104.

The first actuation element 108 has (a) an outer surface 1081 that is electrically coupled to conductive semiconductors 133 for receiving one or more actuation signals, (b) one or more intermediate parts 1081 that pass through the movable member 104, and (c) an inner surface 127 (that can be made of transparent conducting oxide) that is electrically coupled to the one or more intermediate parts.

An optical gap do is formed between stationary member 102 and movable member 104 and may define the spectral response of the tunable filter 100. The optical gap is defined by an actuation gap go between the inner surface of the first actuation element 108 and the second actuation elements 118. The value of the actuation gap is defined by a provision (or lack of provision) of actuation signals.

Cavities 117 are formed in the static member 102. Placing an upper part of the second actuation elements 118 within the cavities 117—increases the actuation gap—and obtaining a difference between the actuation gap and the optical gap.

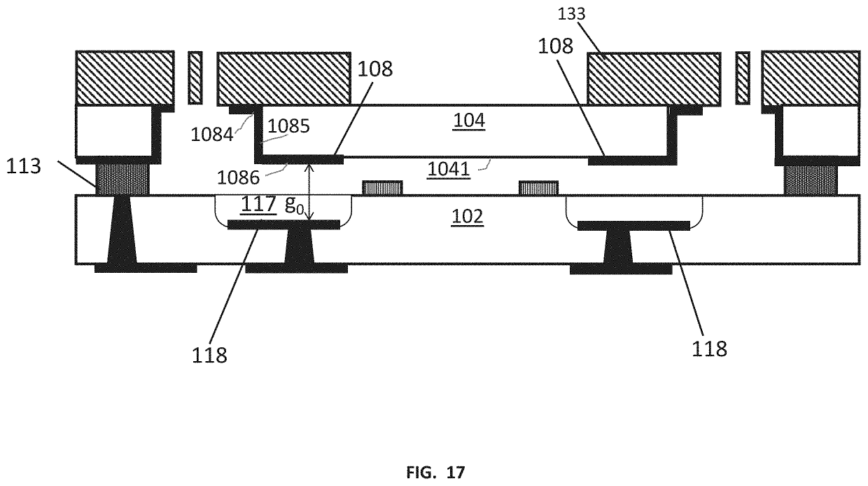

FIG. 17 is a cross section of a tunable filter 100 that includes, stationary member 102, movable member 104, stopper elements 106, one or more first actuation elements 108, static frame 112, one or more flexible elements 114 that is mechanically coupled between frame 112 and first actuation elements 108, one or more second actuation elements 118 and a bond formed between frame 112 and static element 102.

The first actuation elements 108 are connected to the movable member 104. The first actuation elements 108 follow a movement of the movable member. The one or more flexible elements 114 support the movable member 104 regardless of the position of the movable member 104.

Each one of the first actuation elements 108 has (a) an outer surface 1084 that is electrically coupled to conductive semiconductors 133 for receiving one or more actuation signals, (b) an intermediate part 1085 that is connected to sidewalls of the movable member 104, and (c) an inner surface 1086 that contacts the inner surface 1041 of the movable member 104.

An optical gap do is formed between stationary member 102 and movable member 104 and may define the spectral response of the tunable filter 100. The optical gap is defined by an actuation gap go between the inner surface of each one of the first actuation elements 108 and the second actuation elements 118. The value of the actuation gap is defined by a provision (or lack of provision) of actuation signals.

Cavities 117 are formed in the static member 102. Placing an upper part of the second actuation elements 118 within the cavities 117—increases the actuation gap—and obtaining a difference between the actuation gap and the optical gap.

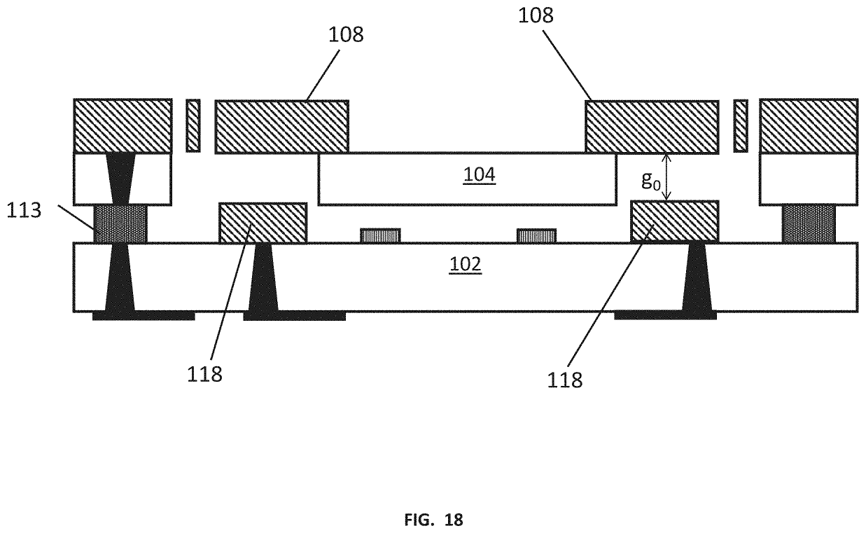

FIG. 18 is a cross section of a tunable filter 100 that includes, stationary member 102, movable member 104, stopper elements 106, one or more first actuation elements 108, static frame 112, one or more flexible elements 114 that is mechanically coupled between frame 112 and first actuation elements 108, one or more second actuation elements 118 and a bond formed between frame 112 and static element 102.

The first actuation elements 108 are connected on top of the movable member 104. The first actuation elements 108 follow a movement of the movable member. The one or more flexible elements 114 support the movable member 104 regardless of the position of the movable member 104.

An optical gap do is formed between stationary member 102 and movable member 104 and may define the spectral response of the tunable filter 100. The optical gap is defined by an actuation gap go between the inner surface of each one of the first actuation elements 108 and the second actuation elements 118. The value of the actuation gap is defined by a provision (or lack of provision) of actuation signals.

The upper part of the second actuation elements 118 are placed on top of the static member 102. The first actuation elements 108 are connected on top of the movable member 104. The movable member 104 is thicker than the second actuation elements 118—thereby obtaining a difference between the actuation gap and the optical gap.

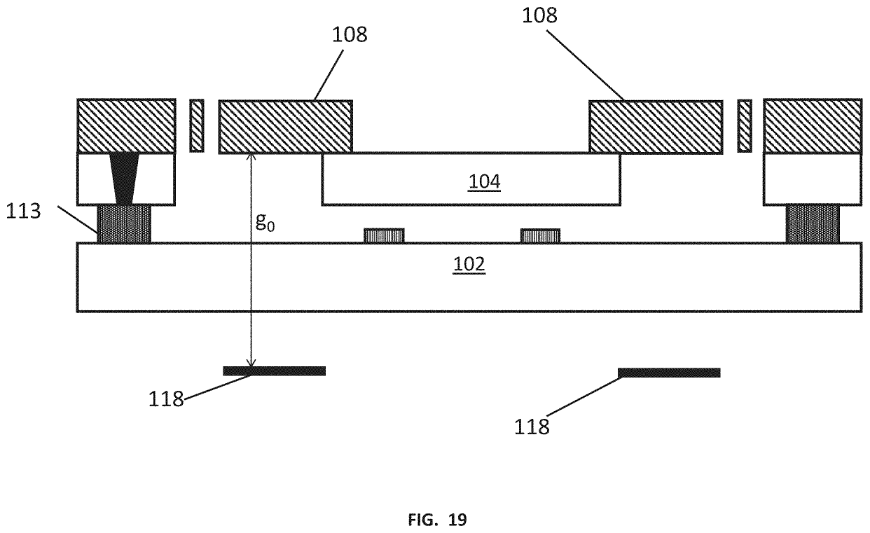

FIG. 19 is a cross section of a tunable filter 100 that includes, stationary member 102, movable member 104, stopper elements 106, one or more first actuation elements 108, static frame 112, one or more flexible elements 114 that is mechanically coupled between frame 112 and first actuation elements 108, one or more second actuation elements 118 and a bond formed between frame 112 and static element 102.

The first actuation elements 108 are connected on top of the movable member 104. The first actuation elements 108 follow a movement of the movable member. The one or more flexible elements 114 support the movable member 104 regardless of the position of the movable member 104.

An optical gap do is formed between stationary member 102 and movable member 104 and may define the spectral response of the tunable filter 100. The optical gap is defined by an actuation gap go between the inner surface of each one of the first actuation elements 108 and the second actuation elements 118, wherein the second actuation elements 118 in this exemplary embodiment are disposed external to the tunable filter, namely external to the sealed enclosure that includes the optical components of the tunable filter. The value of the actuation gap is defined by a provision (or lack of provision) of actuation signals. The static member 108 is positioned between the second actuation elements 118 and the movable member 104—thereby obtaining a difference between the actuation gap and the optical gap.

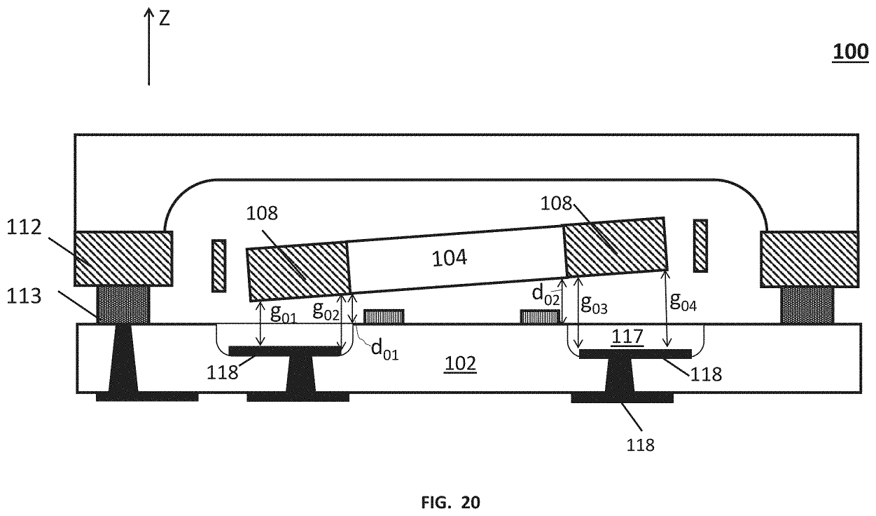

FIG. 20 illustrates cross sections of a tunable filter 100 that includes cap 101, stationary member 102, movable member 104, stopper elements 106, one or more first actuation elements 108, static frame 112, one or more flexible elements 114 such as a spring that is mechanically coupled between frame 112 and first actuation elements 108, one or more second actuation elements 118 and a bond formed between frame 112 and static element 102.

The first actuation elements 108 are connected to the movable member 104. The first actuation elements 108 follow a movement of the movable member. The one or more flexible elements 114 support the movable member 104 regardless of the position of the movable member 104.

Cavities 117 are formed in the static member 102. Placing an upper part of the second actuation elements 118 within the cavities 117—increases the actuation gap—and obtaining a difference between the actuation gap and the optical gap.

In FIG. 20 the movable member 104 and the one or more first actuation elements 108 are not parallel to the one or more second actuation elements 118. This is illustrated by a first range of actuation gaps g₀₁-g₀₂ (between the left first actuation element 108 and the left second actuation element 118), a second range of actuation gaps g₀₃-g₀₄ (between the right first actuation element 108 and the right second actuation element 118), and a range of optical gaps d₀₁-d₀₂ (between the movable member 102 and the static member 104). The different ranges of optical gaps is achieved by applying different actuation signals between different actuation elements.

The smallest actuation gap (g₀₁) may exceed the largest optical gap (d₀₁).

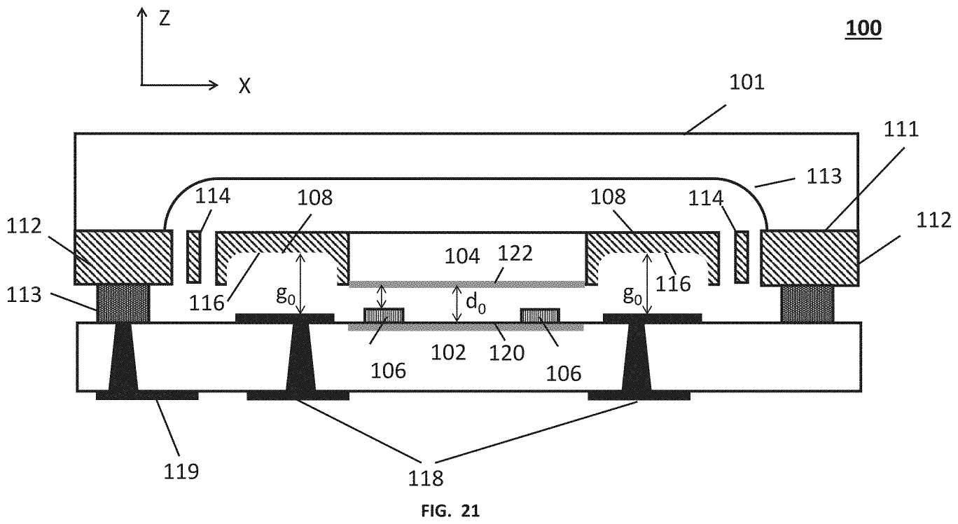

FIG. 21 illustrates a cross sections of a tunable filter 100 that includes cap 101, stationary member 102, movable member 104, stopper elements 106, one or more first actuation elements 108, static frame 112, one or more flexible elements 114 such as a spring that is mechanically coupled between frame 112 and first actuation elements 108, one or more second actuation elements 118 and a bond (113) formed between frame 112 and static element 102.

The first actuation elements 108 are connected to the movable member 104. The first actuation elements 108 follow a movement of the movable member. The one or more flexible elements 114 support the movable member 104 regardless of the position of the movable member 104.

FIG. 21 also illustrates an optical coating 122 applied on the inner surface of movable member 104 and an optical coating 120 applied on the inner surface of stationary member 102. Each optical coating may be at least partially reflective coatings. Such optical coating may be applied on any of the tunable filter of any one of the filters.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

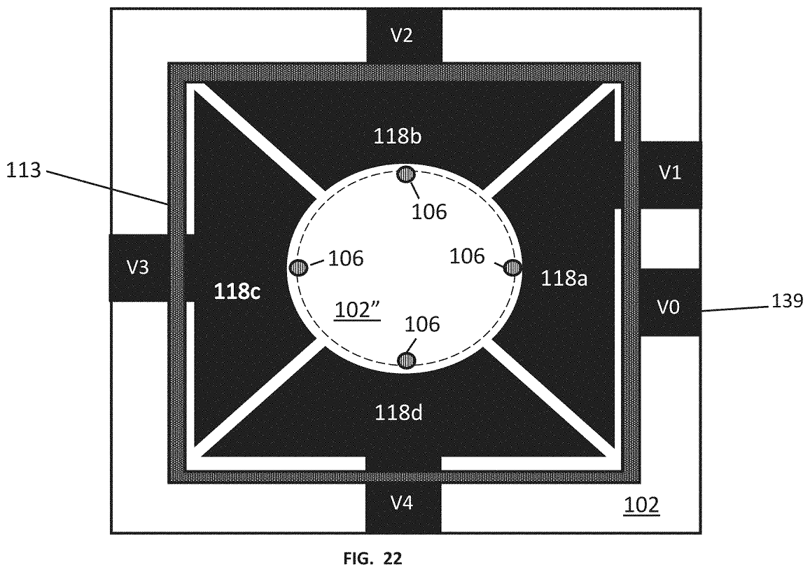

FIG. 22 shows a top view of the fixed member of FIG. 14. In this example, four control electrodes (second actuating elements) 118a, 118b, 118c and 118d are formed on the fixed member 102—surrounding the center 102″ of the static member—with their contact pads V1-V4. Contact pad V0 139 for the top electrode of the movable member is also shown and is coupled to dielectric bond 113 that surrounds a majority of the electrodes.

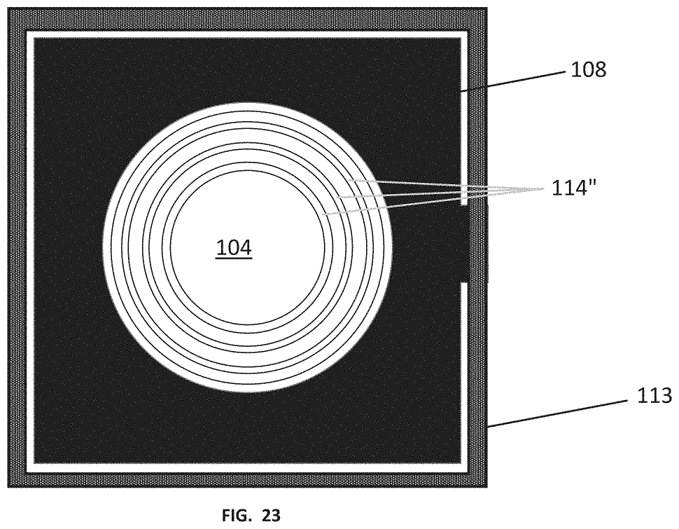

FIG. 23 shows a bottom view of the movable member of FIG. 14. A single ground electrode (first actuating element) 108 is formed on the movable member. In this example, the movable member 104 is made of a flexible material, for example a transparent polymer or a sufficiently thin layer. Flexible sealing element 114″ (such a membrane), minimizes the bending of the optical region due to deflection of the actuation element 108.

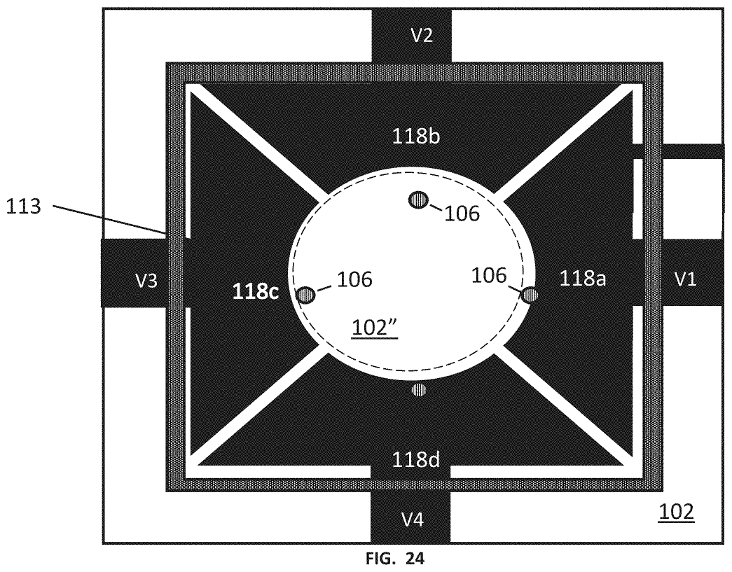

FIG. 24 shows a top view of the fixed member of FIG. 14. In this example, four control electrodes (second actuating elements) 118a, 118b, 118c and 118d are formed on the fixed member 102—surrounding the center 102″ of the static member—with their contact pads V1-V4.

FIGS. 15-19 demonstrate the use of a silicon-on-glass wafer which is formed from a glass containing through-glass-vias, electrical contact between the vias and the silicon in the anodically bonded interface could be assured by various means, including utilizing the method in the publication “Si-gold-glass hybrid wafer bond for 3D-MEMS and wafer level packaging” (doi.org/10.1088/0960-1317/27/1/015005).

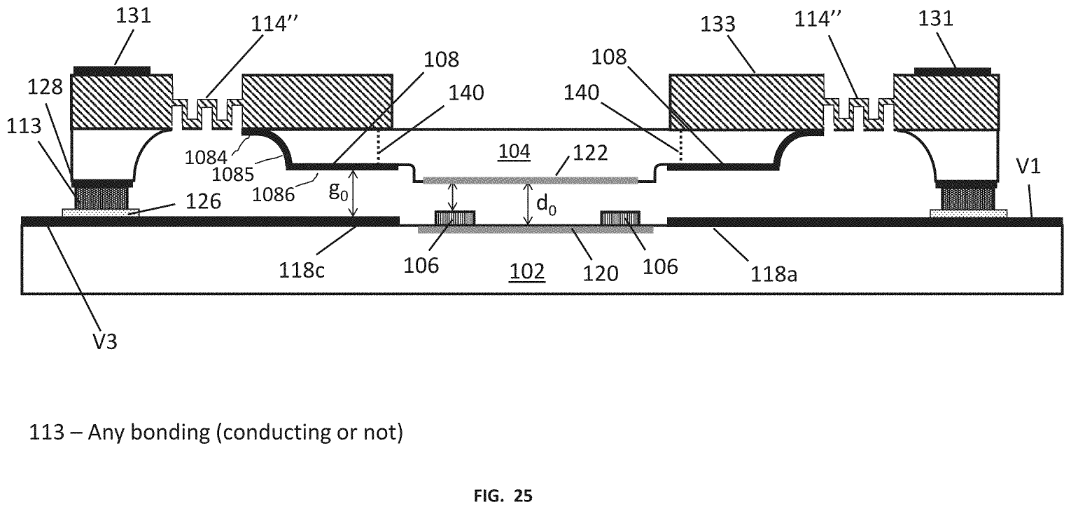

FIG. 25 illustrates a cross section of a tunable filter that includes stationary member 102, movable member 104, stopper elements, one or more first actuation elements 108, static frame, one or more flexible elements 114″ (such as flexible membrane) that is mechanically coupled between the frame and first actuation elements 108, first and second actuation elements 118a and 118b, bond 113 formed between the frame and an electrically insulating layer 126 that is formed above static member 102.

The first actuation elements 108 are connected to the movable member 104. The first actuation elements 108 follow a movement of the movable member. The one or more flexible elements 114 support the movable member 104 regardless of the position of the movable member 104.

Each one of the first actuation elements 108 has (a) an outer surface 1084 that is electrically coupled to conductive semiconductors 133 for receiving one or more actuation signals, (b) an intermediate part 1085 (in FIG. 24 it is curved) that is connected to sidewalls of the movable member 104, and (c) an inner surface 1086 that contacts the inner surface 1041 of the movable member 104.

An optical gap dₒ is formed between stationary member 102 and movable member 104 and may define the spectral response of the tunable filter 100. The optical gap is defined by an actuation gap go between the inner surface of each one of the first actuation elements 108 and the second actuation elements 118a and/or 118b. The value of the actuation gap is defined by a provision (or lack of provision) of actuation signals.

FIG. 25 also illustrates optical coatings 120 and 122 deposited on an inner surfaces of the movable member 104 and static member 102, respectively.

The optical coatings are closer to each other in relation to the distance between first actuation elements 108 and second actuation elements 118a and 118a.

Slots 140 are formed in the movable member 104. These slots may be used for stress relief. In FIG. 24 the slots are formed between the conductive semiconductors 133 and the first actuation elements 108. Other locations may be provided.

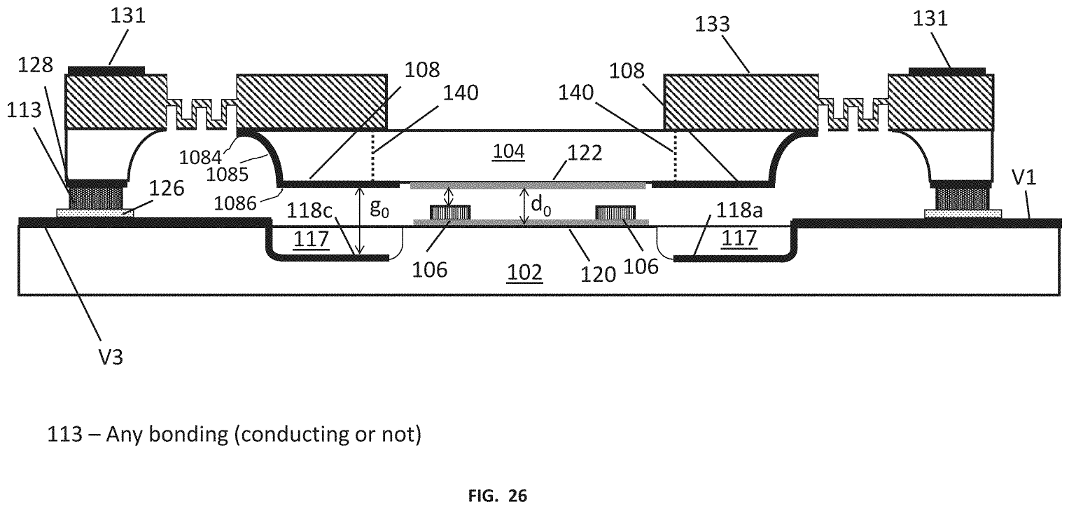

FIG. 26 illustrates a cross section of a tunable filter.

The tunable filter of FIG. 26 differs from the tunable filter of FIG. 25 by: (a) having cavities 117 formed in the stationary member 102, (b) having a part of second actuation element 118a formed within a part of a first cavity of cavities 117, and (c) having a part of second actuation element 118b formed within a part of a second cavity of cavities 117.

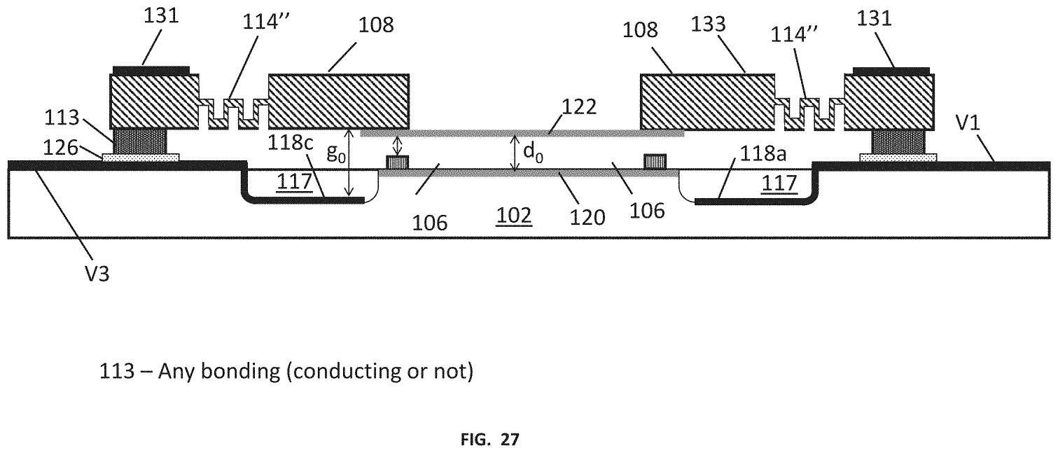

FIG. 27 illustrates a cross section of a tunable filter that includes stationary member 102, movable element that consists essentially of a layer of optical coating 122. The tunable filter also includes stopper elements 106, one or more first actuation elements 108 coupled to the layer of optical coating 122, static frame 112, one or more flexible elements 114″ (such as flexible membrane) that is mechanically coupled between the frame 112 and first actuation elements 108, first and second actuation elements 118a and 118b, bond 113 formed between the frame and an electrically insulating layer 126 that is formed above static member 102. Static member 102 includes or is coupled to optical coating 120.

Cavities 117 are formed in the stationary member 102.

A part of second actuation element 118a is formed within a part of a first cavity of cavities 117.

A part of second actuation element 118b is formed within a part of a second cavity of cavities 117.

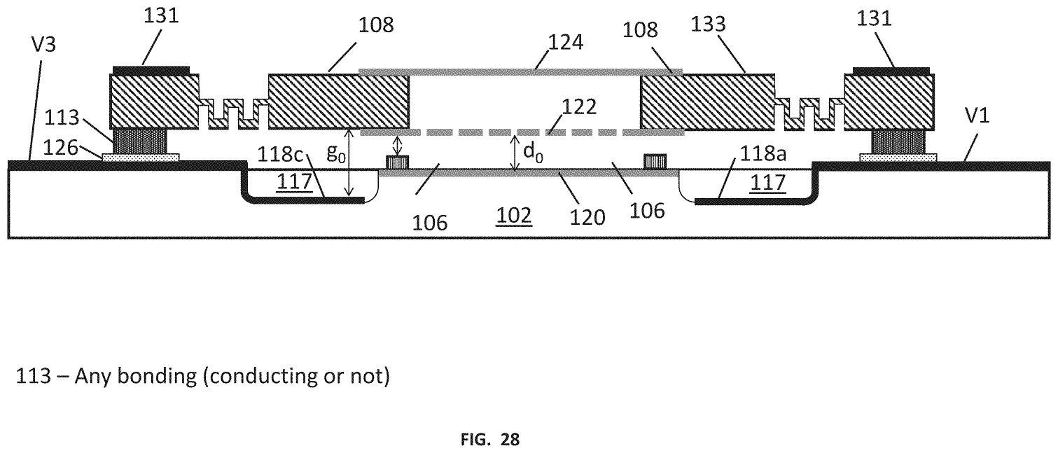

FIG. 28 illustrates a cross section of a tunable filter that includes stationary member 102, movable element that consists essentially of a layer of optical coating 122 that is perforated and another layer of optical coating 124. The tunable filter also includes stopper elements 106, one or more first actuation elements 108, static frame 112, one or more flexible elements 114″ (such as flexible membrane) that is mechanically coupled between the frame 112 and first actuation elements 108, first and second actuation elements 118a and 118b, bond 113 formed between the frame and an electrically insulating layer 126 that is formed above static member 102. Static member 102 includes or is coupled to optical coating 120.

The other layer of optical coating 124 may be non-perforated and is connected to top surfaces of the first actuation elements 108.

The bottom of the one or more first actuation elements 108 is connected to a second layer of optical coating 122.

Cavities 117 are formed in the static member 102.

A part of second actuation element 118a is formed within a part of a first cavity of cavities 117.

A part of second actuation element 118b is formed within a part of a second cavity of cavities 117.

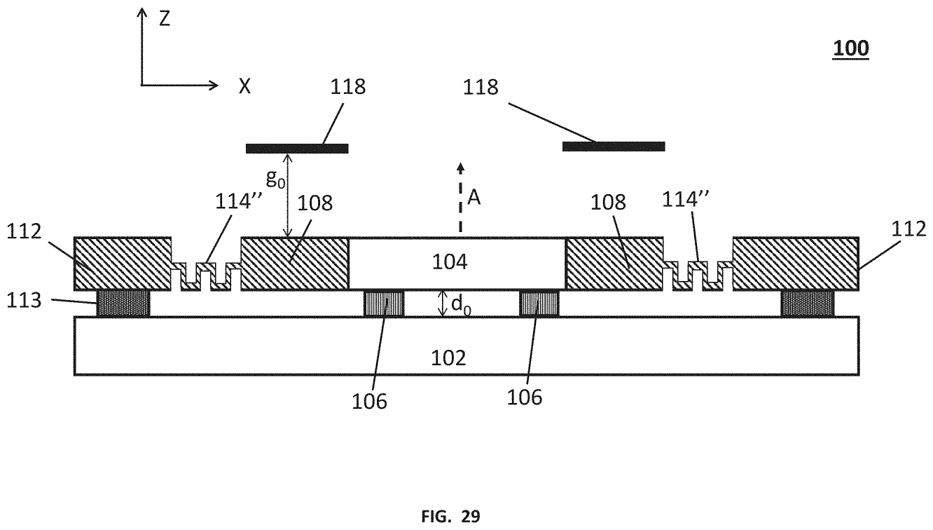

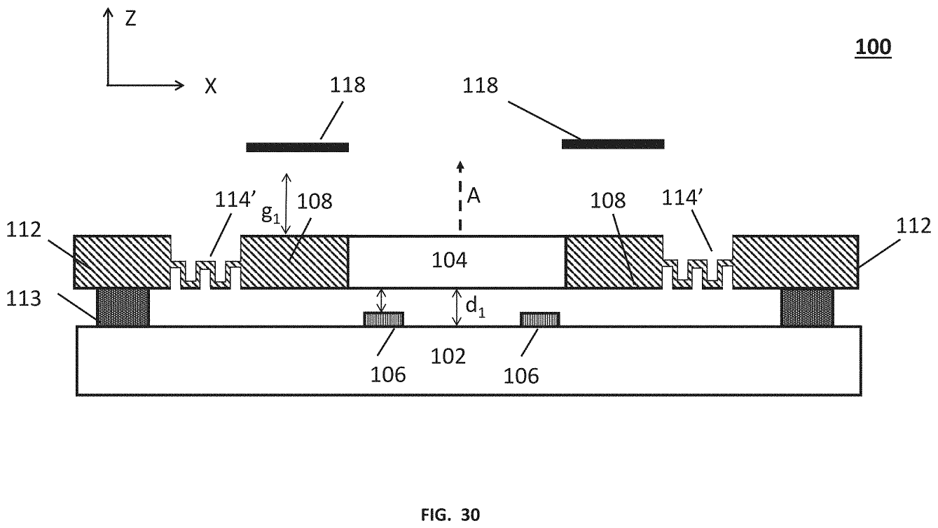

FIGS. 29-30 exemplify an embodiment of the tunable filter of the present disclosure, in which the second actuation regions/elements are external to the hermetic enclosure that is defined between the movable member and the stationary member.

FIGS. 29 and 30 are cross sections of a tunable filter that includes, stationary member 102, movable member 104, stopper elements 106, one or more first actuation elements 108, static frame 112, one or more flexible elements 114″ that have a serpentine cross section and are mechanically coupled between frame 112 and first actuation elements 108—and hermetically seal the gap between the frame 112 and first actuation elements 108 (thereby eliminating the need to have a cap), second actuation elements 118 and a bond 113 formed between frame 112 and static element 102. The one or more flexible elements may have a radial symmetry—thus forming a flexible membrane/corrugated diaphragm.

The first actuation elements 108 are connected to the movable member 104 and may be in the same plane. The first actuation elements 108 follow a movement of the movable member (towards the second actuation elements 118 or away from the second actuation elements 118). The one or more flexible elements 114″ support the movable member 104 regardless of the position of the movable member 104.

The second actuation elements 118 are located outside an inner space defined between the static member and the movable member. The the movable member 104, the first actuation elements 108 and the one or more flexible elements 114″ are positioned between (a) second actuation elements 118 and the static member 102.

An optical gap do is formed between stationary member 102 and movable member 104 and may define the spectral response of the tunable filter 100. The optical gap is defined by an actuation gap go between the first actuation elements 108 and the second actuation elements 118. The value of the actuation gap is defined by a provision (or lack of provision) of actuation signals.

In FIG. 30 the stopper elements 106 is spaced apart from the movable member 104 while in FIG. 29 the stopper elements 106 contact the movable member 104.

The terms “including”, “comprising”, “having”, “consisting” and “consisting essentially of” are used in an interchangeable manner. For example—any method may include at least the steps included in the figures and/or in the specification, only the steps included in the figures and/or the specification. The same applies to the device or tunable filter and the mobile computer.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front, ” “back, ” “top, ” “bottom, ” “over, ” “under ” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one as or more than one. Also, the use of introductory phrases such as “at least one ” and “one or more ” in the claims should not be construed to imply that the introduction of another claim element by the indefinite articles “a ” or “an ” limits any particular claim containing such introduced claim element to inventions containing only one such element, even when the same claim includes the introductory phrases “one or more ” or “at least one ” and indefinite articles such as “a ” or “an. ” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements the mere fact that certain measures are recited in mutually different claims does not indicate that a combination of these measures cannot be used to advantage.

Any system, apparatus or device referred to this patent application includes at least one hardware component.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Any combination of any component of any component and/or unit of device or of a tunable filter that is illustrated in any of the figures and/or specification and/or the claims may be provided.

Any combination of any device or any tunable filter illustrated in any of the figures and/or specification and/or the claims may be provided.

1-57. (canceled)

58. A tunable filter, comprising:
a moveable member and a stationary member, the moveable member is configured to move with respect to the stationary member;
the moveable member comprises a first optical component and a first actuation element and the stationary member comprises a second optical component and a second actuation element, wherein there is an optical gap between the first and second optical components; and
the first and second actuation elements are configured, once supplied with at least one actuating signal, to be positioned at an actuation gap from each other and to define the optical gap, wherein the optical gap is substantially smaller than the actuation gap;
wherein the moveable member either comprises the first optical component or is mechanically coupled to the first optical component and; wherein the moveable member is formed of or comprises silicon and the stationary member is formed of or comprises glass and an inner surface of the first actuating element is positioned within a recess formed by etching of the moveable member;
wherein the moveable member is physically connected to a flexible member that allows movement of the moveable member upon application of the actuation signal.

59. The tunable filter of claim 58, wherein the flexible member is undulated/corrugated shaped.

60. The tunable filter of claim 58, wherein the moveable member, the flexible member and the stationary member, enclose a gas-tight sealed chamber.

61. The tunable filter of claim 60 does not include a cap otherwise used for sealing.

62. The tunable filter of claim 58, wherein the first actuating element is configured to move the first optical component in relation to a frame of the tunable filter; wherein a flexible element of the tunable filter is mechanically coupled to the frame and to the first optical element.

63. The tunable filter of claim 62, wherein the flexible element is configured to seal a gap between the frame and the first optical component.

64. The tunable filter of claim 58, wherein an inner surface of the first optical component faces an inner surface of the second optical component; and wherein an inner surface of the first actuating element faces an inner surface of the second actuating element.

65. The tunable filter of claim 58, wherein the inner surface of the first actuating element is a part of a bottom of a first recess formed within the first actuating element.

66. The tunable filter of claim 58, wherein the tunable filter is a Fabry-Perot filter.

67. The tunable filter of claim 58, wherein the optical gap determines, at least in part, a parameter of an optical filtering operation applied by the tunable filter.

68. The tunable filter of claim 58, wherein a maximal optical gap is obtained without providing the at least one actuation signal to first and/or second actuating elements.

69. The tunable filter of claim 60, wherein the second actuation element is disposed external to the chamber sealed between the moveable member and stationary member.

70. The tunable filter of claim 58, wherein the moveable member is made of a combination of silicon and glass.

71. A tunable filter, comprising:
a moveable member and a stationary member, the moveable member is configured to move with respect to the stationary member;
the moveable member comprises a first optical component and a first actuation regions and the stationary member comprises a second optical component and a second actuation regions, wherein there is an optical gap between the first and second optical components; and
the first and second actuation regions are configured, once supplied with at least one actuating signal, to be positioned at an actuation gap from each other and to define the optical gap;
wherein the moveable member either comprises the first optical component or is mechanically coupled to the first optical component;
wherein the moveable member is physically connected to a flexible member that allows movement of the moveable member upon application of the actuation signal; and wherein the flexible member is undulated/corrugated shaped and configured and wherein the moveable member, the flexible member and the stationary member, enclose a gas-tight sealed chamber.

72. The tunable filter of claim 71, wherein the flexible member links the moveable member to a static frame such that the gap spanned between the moveable member and the stationary member is sealed to the ambient environment.

73. The tunable filter of claim 71, wherein and an inner surface of the first actuating element is positioned within a recess formed in the moveable member.

74. The tunable filter of claim 71 wherein the flexible member has a radial symmetry.

75. The tunable filter of claim 71 wherein the flexible member has a serpentine shaped cross section.

76. The tunable filter of claim 71, wherein the first actuation regions constitute one or more portions of the first member.

77. The tunable filter of claim 71, wherein the second actuation regions is disposed external to the gas-tight sealed chamber.

78. The tunable filter of claim 71, wherein the second actuation regions is formed on the second member.

79. The tunable filter of claim 71, wherein the first actuation regions are formed in one or more recesses in a portion of the first member.

80. The tunable filter of claim 71, wherein the moveable member is integral with a first end of a corrugated/undulated flexible member that permits its movement that result in the tuning of the optical gap, the second end of the corrugated/undulated flexible member is integral with a static frame.

81. The tunable filter of claim 71, wherein the flexible member constitutes a part of the first member.

82. The tunable filter of claim 71 is MEMS-based etalon filter.

83. The tunable filter of claim 71, wherein the moveable member is formed of or comprises silicon and the stationary member is formed of or comprises glass.

84. A tunable filter, comprising:
a moveable member and a stationary member, the moveable member is configured to move with respect to the stationary member;
the moveable member comprises a first optical component and a first actuation element and the stationary member comprises a second optical component and a second actuation element, wherein there is an optical gap between the first and second optical components; and
the first and second actuation elements are configured, once supplied with at least one actuating signal, to be positioned at an actuation gap from each other and to define the optical gap, wherein the optical gap is substantially smaller than the actuation gap;
wherein the moveable member either comprises the first optical component or is mechanically coupled to the first optical component and an inner surface of the first actuating element is positioned within a recess formed in the moveable member;
wherein the moveable member is physically connected to a flexible member that allows movement of the moveable member upon application of the actuation signal; and wherein the flexible member is undulated/corrugated shaped.
